(19) United States
(12) Patent Application Publication
(10) Pub. No.: US 2015/0029707 A1
(43) Pub. Date: Jan. 29, 2015

(54) ADJUSTABLE BEAM FLASHLIGHT

(71) Applicant: Chung T. Cheng, Alpharetta, GA (US)

(72) Inventor: Chung T. Cheng, Alpharetta, GA (US)

(21) Appl. No.: 13/950,478

(22) Filed: Jul. 25, 2013

(51) Int. Cl. F21L 4/00

(52) U.S. Cl. CPC F21L 4/00
USPC 362/187

(57) ABSTRACT

An adjustable flashlight (10) is disclosed having a housing (11)and a light assembly (12). The housing includes a main body portion (15), an end cap (17), a coupler (19), and LED mounting plate (25). The housing also includes a guide tube (27) with a longitudinally extending elongated slot (37). The flashlight also has a lens assembly (40) having a lens sliding ring (41) and a lens (42). The lens sliding ring is telescopically mounted within the stepped guide tube for longitudinal movement therein. The lens sliding ring includes a guide pin (44) which extends through the elongated slot and into a helical groove (49) within an adjustment ring (46) telescopically mounted to the guide tube. The light assembly includes a LED light source (51) and a battery (57). Rotational movement of the adjustment ring causes linear, longitudinal movement of the lens assembly.

### TECHNICAL FIELD

This invention relates to flashlights, and more specifically to flashlights having an adjustable beam.

### BACKGROUND OF THE INVENTION

Flashlights typically include a battery, a light bulb and a reflector surrounding the light bulb. The intensity of the light produced by the flashlight may be varied by moving the position of the light bulb relative to the position of the stationary reflector, thereby focusing the light between a wide beam or a narrow beam.

Today's flashlights often include an LED as the light source rather than a conventional incandescent light bulb. The LED however cannot be easily moved relative to the reflector to change the intensity. However, LED flashlights may incorporate a separate lens that can be moved relative to the LED to vary the intensity by changing the focus. This type of flashlight is shown in U.S. Pat. Nos. 7,461,945 and 8,147,088.

These flashlights have longitudinally adjustable elements which move the lens to change the focal length. A problem however occurs when such flashlights are mounted to rifles or pistols. As a firearm is discharged the firearm is quickly and violently moved longitudinally. This abrupt longitudinal movement can cause the adjustable element to longitudinally move as well, thereby changing the focus of the lens with each firing of the firearm and forcing the undesirable manual readjustment of such.

Accordingly, it is seen that a need remains for a flashlight which does not change the focus of the light beam should it be abruptly moved in the longitudinal direction. It is to the provision of such therefore that the present invention is primarily directed.

### SUMMARY OF THE INVENTION

In a preferred form of the invention a flashlight comprises a longitudinally extending housing having at least a main body portion, a guide tube having a longitudinal slot therethrough, an adjustment ring telescopically mounted about the guide tube for rotational movement thereabout and having an interior surface with a helical groove therein, and a lens sliding ring telescopically mounted within the guide tube for longitudinal movement therein. The lens slide ring has an outwardly extending guide pin which extends through the guide tube elongated slot and into the adjustment ring helical groove. The flashlight also includes a lens coupled to the lens slide ring, a light source coupled to the main body portion, and a battery electrically coupled to the light source. With this construction, the rotational movement of the adjustment ring causes the guide pin of the lens sliding ring to move along the helical groove and thereby causing the guide pin to move along the elongated slot of the guide tube to cause the lens sliding ring and lens to move longitudinally within the guide tube to vary the distance between the lens and the light source thereby changing the focus of the light produced by the light source.

### BRIEF DESCRIPTION OF THE DRAWING

FIG. 1 is a perspective view of an adjustable beam flashlight embodying principles of the invention in a preferred form.

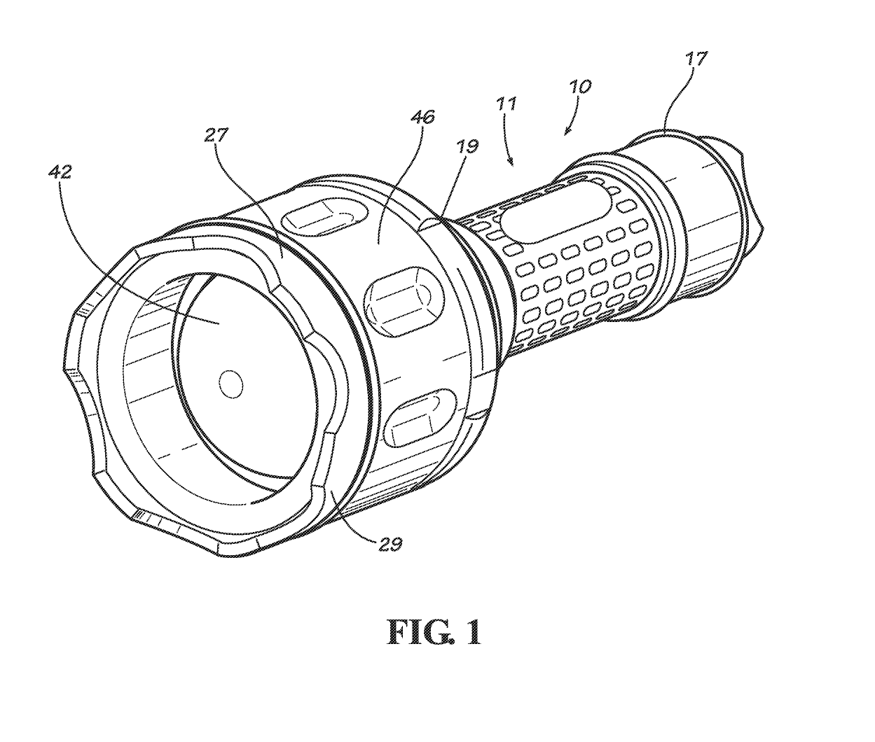

FIG. 2 is an exploded view of the adjustable beam flashlight of FIG. 1.

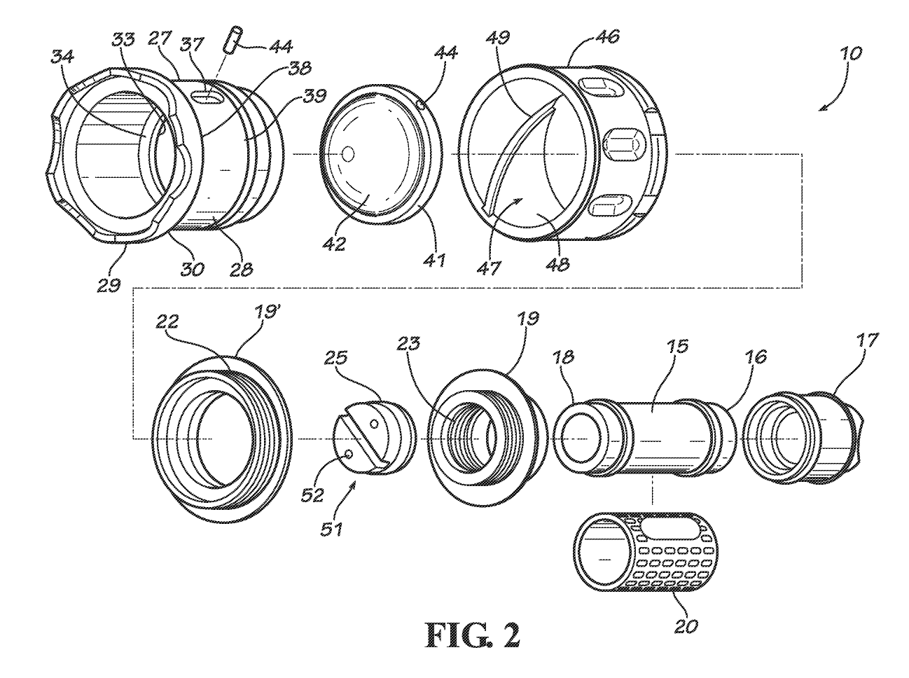

FIG. 3 is a cross-sectional view of the adjustable beam flashlight of FIG. 1.

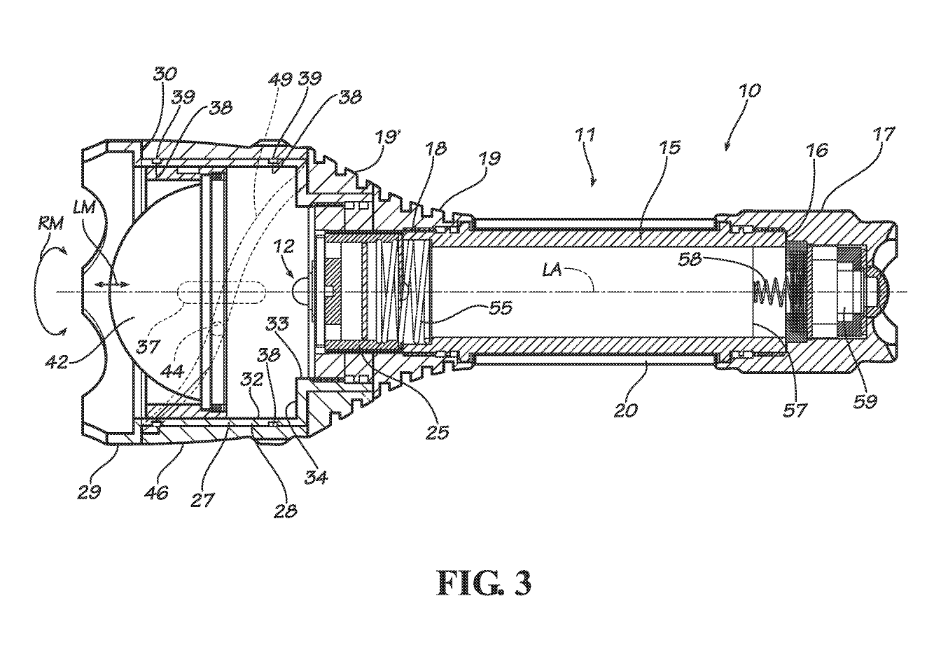

### DETAILED DESCRIPTION

With reference next to the drawings, there is shown an adjustable beam flashlight 10 in a preferred form of the invention. The flashlight 10 has a tubular housing 11 and a light assembly 12. The tubular housing extends longitudinally along longitudinal axis LA.

The housing 11 includes a metal or electrically conductive tubular handle or main body portion 15 having a first end 16 with external threads upon which is threaded an internally threaded end cap 17 and a second end 18 with external threads upon which is threaded an internally threaded coupler 19 (shown in the drawings with a two piece construction 19 and 19′). The main body portion 15 may include a rubber or electrically insulative exterior sleeve 20. The threaded coupler 19 also has an externally threaded end 22 opposite the main body portion 15 and internal threads 23. An externally threaded LED mounting plate 25 is threaded onto the threaded coupler's internal threads 23.

The housing 11 also includes an inwardly stepped guide tube 27 which includes internal threads which are threaded upon the external threads of the threaded coupler externally threaded end 22. The stepped guide tube 27 has an elongated neck 28 extending from an externally enlarged end portion 29 having an external ledge or stop wall 30. The stepped guide tube 27 also has a longitudinally extending internal channel 31 having a first portion 32 with a select internal diameter and a second portion 33 with a select internal diameter which is smaller than the first portion 32 internal diameter so as to form an inwardly extending internal ledge or stop wall 34. The neck 28 has a longitudinally extending elongated slot 37 extending from the internal channel second portion 33 to the exterior of the guide tube 27. The neck 28 has two annular grooves 38 in which are mounted resilient O-rings 39. Optionally, the stepped guide tube may include a transparent protective shield to seal and protect the front end of the flashlight.

The flashlight also has a lens assembly 40 which includes a generally cylindrical lens sliding ring 41 and a convex lens 42 coupled to the lens sliding ring 41. The lens sliding ring 41 is telescopically mounted within the stepped guide tube 27 for linear, longitudinal sliding movement therein, indicated by arrow LM. The lens sliding ring 41 includes a guide pin 44 extending radially outward from the exterior surface of the lens sliding ring 41. The guide pin 44 extends through the elongated slot 37 of the stepped guide tube 27 so as to extend from the exterior surface of the stepped guide tube 27. The positioning of the guide pin 44 within the elongated groove 37 limits the extent of longitudinal movement LA on the lens sliding ring 41, and thereby lens 42, relative to the stepped guide tube 27 and prevents relative rotational movement of the lens sliding ring.

Lastly, the housing 11 includes a generally cylindrical, adjustment ring 46 telescopically mounted to the exterior of the stepped guide tube 27 and limited by its abutment with the stepped guide tube stop wall 30. The adjustment ring 46 has a central channel 47 defined by an interior surface 48 and a helical groove 49 extending from the interior surface 48. The term helical groove herein is intended to include a portion of a helical groove. The portion of the guide pin 44 which extends outwardly from the stepped guide tube 27 is positioned or resides within the helical groove 49. The O-rings 39 contact the interior surface 48 of the adjustment ring to restrict free movement of the adjustment ring 46 relative to the stepped guide tube 27, so that a person must physically cause relative rotational movement therebetween.

The light assembly 12 includes a light source 51 in the form of one or more light emitting diodes (LED) 52 mounted to the LED mounting plate 25 with the light emitting portion of the LED 52 facing towards the lens 42 along the longitudinal axis LA. The LED 52 has a centrally located first LED contact 53 while the LED mounting plate 25 itself acts as a second contact. The first LED contact 53 is also a first battery contact, as the battery (typically a conventional dry cell battery) positive terminal directly contacts the first LED contact 53. A metal spring 55 extends between and in electrical contact with the metallic main body portion 15 and the peripheral portion of the LED mounting plate which acts as a second LED contact.

The light assembly 12 also includes at least one battery 57 positioned within the interior of the main body portion 15. The negative terminal of the battery 57 abuts a coil spring 58 coupled to the interior of the end cap 17 threaded onto the main body portion 15. The coil spring 58 is in electrical contact with the metal main body portion 15 through an electrical on/off switch 59 coupled to the end cap 17. As such, the end cap 17 and main body portion 15 act as a conductor from the on/off switch 59 to spring 55.

In use, the on/off switch 59 is actuated to its on position which causes the electrical current from the battery 57 to flow through and activate the LED 52. The light from the LED 52 is focused through the relative longitudinal position or distance between the lens 42 and the LED 52. The relative linear, longitudinal movement or position of the lens 42 is changed by manually rotating the adjustment ring 46, the rotational movement of the adjustment ring is illustrated by arrow RM. As adjustment ring 46 is rotated the guide pin 44 of the lens sliding ring 41 rides along the helical groove 49 of the adjustment ring 46. The longitudinal slot 37 allows for only linear, longitudinal movement of the guide pin and thereby the lens assembly. The longitudinal movement LM of the guide pin 44 within the helical groove 49 causes the guide pin 44 to also move longitudinally along the elongated slot 37 within the stepped guide tube 27, which ensures that the lens sliding ring 41 moves linearly and longitudinally LM within the stepped guide tube. As such, when the adjustment ring 46 is rotated in one rotational direction the lens sliding ring and lens move in one longitudinal direction LM towards or away from the LED 52, and when the adjustment ring 46 is rotated RM in the opposite rotational direction the lens sliding ring and lens move in the opposite longitudinal direction LM towards for away from the LED.

The benefit of the present invention is that in order to move the lens 42 linearly and longitudinally relative to the LED 52, the adjustment ring 46 must be rotationally moved. This is a benefit over the prior art because the abrupt longitudinal movement of the flashlight does not cause unwanted longitudinal movement or repositioning of the lens relative to the LED, a problem that can occur with the firing and resulting forces of a firearm during the discharge of ammunition and its resulting recoiling effect. Of course, the difference in the longitudinal distance between the LED and the lens causes the different focusing of the light produced by the LED resulting in different beams widths and light intensities.

It should be understood that other methods of constructing a rotationally actuated moving means for moving the lens or lens assembly may exists, such as a threaded end cap having a convex lens so that rotation of the end cap causes the longitudinal distance between the lens and the light source to change.

It should be understood that the volume within the main body portion 15 between the end cap 17 and the LED mounting plate 25 remains the same as the adjustment 46 is rotated and the lens moves accordingly. This static volume helps in preventing the intrusion of water into the main body portion through the creation of a suction caused by the movement of the lens, as problem associated with some prior art flashlights with moving lens.

It thus is seen that an adjustable flashlight is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A flashlight comprising,
a longitudinally extending housing having at least a main body portion, a guide tube having a longitudinal slot therethrough, an adjustment ring telescopically mounted about said guide tube for rotational movement thereabout and having an interior surface with a helical groove therein, and a lens sliding ring telescopically mounted within said guide tube for longitudinal movement therein, said lens slide ring having an outwardly extending guide pin which extends through said guide tube elongated slot and into said adjustment ring helical groove,
a lens coupled to said lens slide ring,
a light source coupled to said main body portion, and
a battery electrically coupled to said light source,
whereby the rotational movement of the adjustment ring causes the guide pin of the lens sliding ring to move along the helical groove and thereby causing the guide pin to move along the elongated slot of the guide tube to cause the lens sliding ring and lens to move longitudinally within the guide tube to vary the distance between the lens and the light source thereby changing the focus of the light produced by the light source.

2. The flashlight of claim 1 wherein said light source is a light emitting diode.

3. A flashlight comprising,
a housing,
a light source coupled to said housing,
a battery electrically coupled to said light source,
a lens assembly which is adapted for longitudinal movement relative to said light source to change the focus of light produced by said light source,
rotationally actuated moving means for longitudinally moving said lens assembly relative to said light source in response to the rotational movement of said rotationally actuated moving means.

4. The flashlight of claim 3 wherein said rotationally actuated moving means is oriented for rotational movement about a longitudinal axis extending through said light source and said lens assembly.

5. The flashlight of claim 3 wherein said rotationally actuated moving means includes a guide tube having a longitudinally extending internal channel and an adjustment ring telescopically mounted about said guide tube, and wherein said lens assembly includes a lens and a lens sliding ring telescopically mounted within said guide tube channel for longitudinal movement therein,
whereby rotational movement of said adjustment ring causes longitudinal movement of said lens sliding ring.

6. The flashlight of claim 5 wherein said guide tube includes an elongated slot, wherein said adjustment ring includes an interior surface with a helical groove therein, and wherein said lens sliding ring includes a guide pin extending through said guide tube elongated slot and into said adjustment ring helical groove.

7. A flashlight comprising,
a housing,
a light source coupled to said housing,
a battery electrically coupled to said light source,
a lens assembly movable in a longitudinal direction towards and away from said light source to change the focus of light produced by said light source,
a rotatable actuator coupled to said lens assembly wherein the rotation of the rotatable actuator in one direction causes the lens assembly to move in longitudinal towards said lens assembly and the rotation of the rotatable actuator in an opposite direction causes the lens assembly to move in a opposite longitudinal direction away from said lens assembly.

8. The flashlight of claim 7 wherein said rotatable actuator is oriented for rotational movement about a longitudinal axis extending through said light source and said lens assembly.

9. The flashlight of claim 7 wherein said rotatable actuator includes a guide tube having a longitudinally extending internal channel and an adjustment ring telescopically mounted about said guide tube, and wherein said lens assembly includes a lens and a lens sliding ring telescopically mounted within said guide tube channel for longitudinal movement therein,
whereby rotational movement of said adjustment ring causes longitudinal movement of said lens sliding ring.

10. The flashlight of claim 9 wherein said guide tube includes an elongated slot, wherein said adjustment ring includes an interior surface with a helical groove therein, and wherein said lens sliding ring includes a guide pin extending through said guide tube elongated slot and into said adjustment ring helical groove.
